(19) United States
(12) Patent Application Publication
(10) Pub. No.: US 2024/0051376 A1
(43) Pub. Date: Feb. 15, 2024

(54) VEHICLE SUN VISOR WITH TICKET HOLDER

(71) Applicant: KYOWA SANGYO CORP., Toyota-shi, Aichi (JP)

(72) Inventor: Hiromoto SUZUKI, Toyota-shi (JP)

(73) Assignee: KYOWA SANGYO CORP., Toyota-shi, Aichi (JP)

(21) Appl. No.: 18/265,842

(22) PCT Filed: Dec. 8, 2021
(86) PCT No.: PCT/JP2021/045179

§ 371 Date: Jun. 7, 2023

(30) Foreign Application Priority Data
Dec. 24, 2020 (JP) 2020-214996

(51) Int. Cl. B60J 3/02; F16B 2/20

(52) U.S. Cl. CPC B60J 3/0278; F16B 2/20

(57) ABSTRACT

A vehicle sun visor including a ticket holder that can hold a ticket or the like having a large thickness includes a visor body that has a plate shape. A ticket holder that holds a ticket in cooperation with the visor body is secured to the visor body. The visor body includes an escape portion that passes through or is provided so as to be recessed into a front surface of the visor body, at a position facing the ticket holder.

### TECHNICAL FIELD

The present invention relates to a vehicle sun visor with a ticket holder.

### BACKGROUND ART

Patent Literature 1 discloses a sun visor that includes a ticket holder. The ticket holder includes a plate-shaped holder body made of resin. In the holder body, a boss projecting on a back surface is inserted into an opening hole formed on a sun visor body. The boss is stuck to the sun visor body by an adhesive agent. Thereby, the holder body is secured to the sun visor body. A protrusion for holding is formed on the back surface of the holder body. When a ticket is inserted between the holder body and the sun visor body, the holder body is elastically deformed. Using the elastic deformation of the holder body, the protrusion for holding presses the ticket against the sun visor body. Thereby, the ticket is held between the holder body and the sun visor body.

### CITATION LIST

### Patent Literature

Patent Literature 1: Japanese Patent No. 3115524

### SUMMARY OF THE INVENTION

However, there is a limit on the elastic deformation amount of the holder body. Therefore, there is a limit on the thickness of the ticket that can be held between the holder body and the visor body. Hence, conventionally, a vehicle sun visor including a ticket holder that can hold a ticket having a large thickness is needed.

According to a characteristic of the present disclosure, a vehicle sun visor includes a visor body that has a plate shape. A ticket holder that holds a ticket in cooperation with the visor body is secured to the visor body. The visor body includes an escape portion that passes through or is provided so as to be recessed into a front surface of the visor body, at a position facing the ticket holder.

When the ticket is inserted between the ticket holder and the visor body, the ticket holder is elastically deformed. The ticket is pressed by the ticket holder, and is elastically deformed toward the escape portion. Therefore, the ticket is held between the ticket holder and the visor body, using both of the elastic deformation of the ticket holder and the elastic deformation of the ticket itself. The ticket is elastically deformed toward the escape portion, and therefore, even when the thickness of the ticket is large, the ticket is held between the ticket holder and the visor body, using the escape portion. In other words, the ticket having a large thickness can be held between the ticket holder and the visor body, while the escape portion avoids the ticket holder from being elastically deformed highly.

According to another characteristic of the present disclosure, the ticket holder includes a convex portion that bulges toward the side of the visor body. The escape portion is positioned so as to face the convex portion. Accordingly, the ticket is elastically deformed surely toward the escape portion of the visor body, using the convex portion of the ticket holder. Thus, the ticket can be elastically deformed surely. Moreover, by being pressed by the convex portion, the ticket is restrained from falling out of between the ticket holder and the visor body.

According to another characteristic of the present disclosure, the escape portion of the visor body has such a width length that the escape portion expands beyond both mutually facing edges of the convex portion. Accordingly, the convex portion is positioned within the width of the escape portion. Therefore, a first portion of the ticket that faces the convex portion is easily pressed by the convex portion, into the escape portion or toward the escape portion. On the other hand, second portions of the ticket on both sides of the first portion are easily returned to both sides of the convex portion through the escape portion. Therefore, the ticket can be elastically deformed surely.

According to another characteristic of the present disclosure, the convex portion of the ticket holder includes an inclined surface that gradually advances toward the side of the visor body from a distal end into which a ticket is inserted toward a base portion of the ticket holder. Accordingly, by inserting the ticket into the ticket holder, the ticket is elastically deformed smoothly to the side of the visor body along the convex portion of the ticket holder.

According to another characteristic of the present disclosure, the vehicle sun visor includes a coat that covers the visor body and the escape portion. Accordingly, the ticket holder presses the coat toward the escape portion of the visor body. The coat is elastically deformed so as to be recessed at the escape portion. When the ticket is put in between the coat and the ticket holder, the coat prevents the ticket from being caught by the escape portion. Thereby, the ticket is smoothly put in a gap between the ticket holder and the visor body. Moreover, since the escape portion of the visor body is covered by the coat, the vehicle sun visor having a good appearance is obtained.

According to another characteristic of the present disclosure, the vehicle sun visor includes: a support shaft that is attached to and detached from a vehicle body; and a fixation mount that secures the support shaft to the visor body. The ticket holder is provided on the fixation mount. Accordingly, the ticket holder is secured to the visor body, using the fixation mount that secures the support shaft to the visor body. Thereby, it is possible to reduce the number of components of the vehicle sun visor, or it is possible to simplify the production process for the vehicle sun visor.

According to another characteristic of the present disclosure, a second holder is disposed on a back surface of the front surface of the visor body on which the ticket holder is provided. The ticket holder and the second ticket holder are integrally secured to the visor body. Thereby, the ticket can be held on both surfaces of the visor body, and therefore the ticket holder can be used in the case of both a use position where the visor body is along a windshield and a stowed position where the visor body is along a ceiling surface. Moreover, the two ticket holders are integrated, and therefore are held by the visor body in cooperation.

According to another characteristic of the present disclosure, the vehicle sun visor includes a trim for a vanity mirror that is secured to the visor body. The ticket holder extends from an end edge of the trim. Accordingly, the ticket holder is secured to the visor body by securing the trim for the mirror to the visor body. Thereby, it is possible to reduce the number of components of the vehicle sun visor, or it is possible to simplify the production process for the vehicle sun visor.

### BRIEF DESCRIPTION OF THE DRAWINGS

FIG. 1 is a perspective view of a part of a vehicle interior and a vehicle sun visor attached to a vehicle ceiling.

FIG. 2 is a perspective view of a sun visor body and a ticket holder according to a first embodiment.

FIG. 3 is a plan view showing a state where the ticket holder is secured to the sun visor body according to the first embodiment.

FIG. 4 is a IV-IV line sectional view of FIG. 3.

FIG. 5 is a V-V line sectional view of FIG. 3.

FIG. 6 is a diagram showing a sun visor body according to another embodiment and corresponding to FIG. 5.

FIG. 7 is a diagram showing a ticket holder according to another embodiment and corresponding to FIG. 3.

FIG. 8 is a diagram showing a ticket holder according to another embodiment and corresponding to FIG. 4.

FIG. 9 is a perspective view of a sun visor body and a ticket holder according to another embodiment.

FIG. 10 is a perspective view of a sun visor body and a ticket holder according to another embodiment.

FIG. 11 is a perspective view of a ticket holder according to another embodiment.

FIG. 12 is a perspective view of a ticket holder according to another embodiment.

### MODES FOR CARRYING OUT THE INVENTION

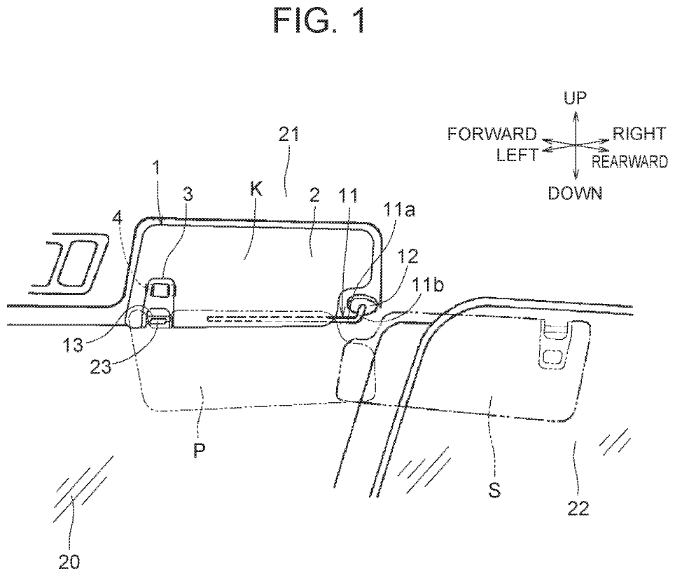

An embodiment of the present invention will be described with use of FIG. 1 to FIG. 5. As shown in FIG. 1, in a vehicle cabin, a vehicle sun visor 1 is secured to a ceiling surface 21 that is adjacent to an upper edge of a windshield 20. The vehicle sun visor 1 includes a visor body 2 that has a plate shape and a ticket holder 3 that is attached to the visor body 2.

As shown in FIG. 1, the visor body 2 is supported on the ceiling surface 21 by a supporting shaft 11, in a rotatable manner. The supporting shaft 11 is a bar having a roughly L-shape, and includes a horizontal shaft 11a and a vertical shaft 11b. The horizontal shaft 11a has a long shaft shape, and is inserted into an edge of the visor body 2, in a rotatable manner. The vertical shaft 11b extends upward from a distal end of the horizontal shaft 11a, so as to be roughly orthogonal to the horizontal shaft 11a. A distal end of the vertical shaft 11b is secured to a bracket 12 in a rotatable manner. The bracket 12 is attached to the ceiling surface 21 in the vehicle cabin.

As shown in FIG. 1, the visor body 2 is detachably secured to a hook 23 fixed to the ceiling surface 21 by a support rod 13. The support rod 13 has a roughly columnar shape. The support rod 13 is attached to the hook 23, and thereby, around an axis center of the support rod 13 and the horizontal shaft 11a, the visor body 2 is turned between a use position P where the visor body 2 is along the windshield 20 and a stowed position K where the visor body 2 is along the ceiling surface 21. By detaching the support rod 13 from the hook 23, the visor body 2 can be turned around the vertical shaft 11b. Thereby, the visor body 2 is turned between the use position P where the visor body 2 is along the windshield 20 and a side position S where the visor body 2 is along a side glass 22.

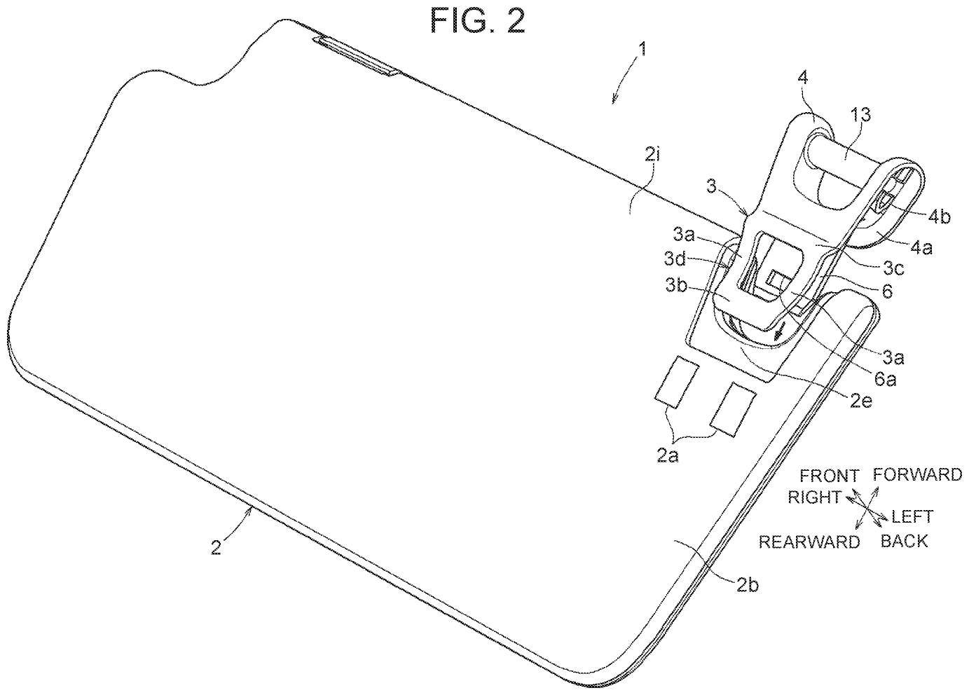

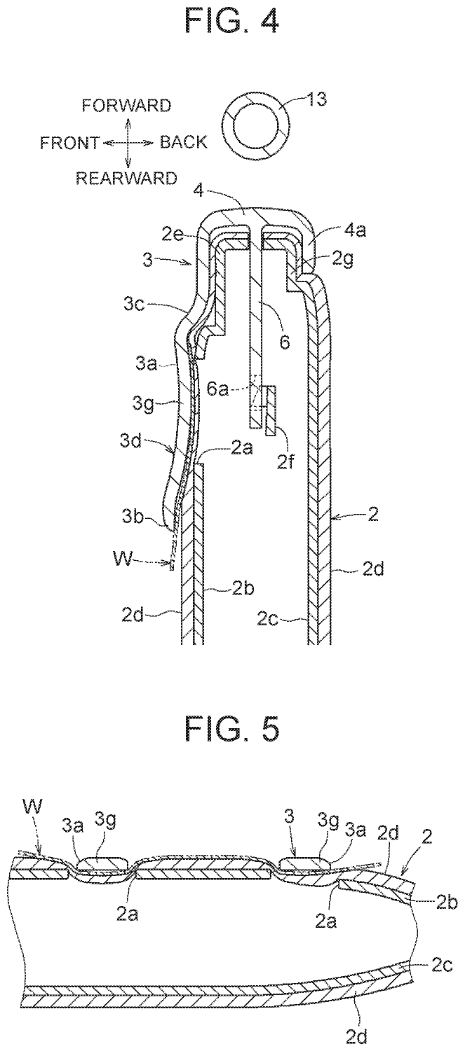

As shown in FIGS. 2 and 4, the visor body 2 includes a first shell 2b and a second shell 2c that have a tabular shape and that overlap in a thickness direction. Hereinafter, forward and rearward directions, right and left directions, and front and back direction are defined on the basis of a state where the visor body 2 is positioned at the stowed position K and is viewed from a user, and descriptions are made. The visor body 2 includes a forward edge 2i to which the support rod 13 is secured. The forward edge 2i includes a holder fixation portion 2e having a shape that is hollowed rearward. A fixation mount 4 including the support rod 13 is secured to the holder fixation portion 2e. A ticket holder 3 is provided on the fixation mount 4. The visor body 2 includes escape portions 2a at a position facing the ticket holder 3.

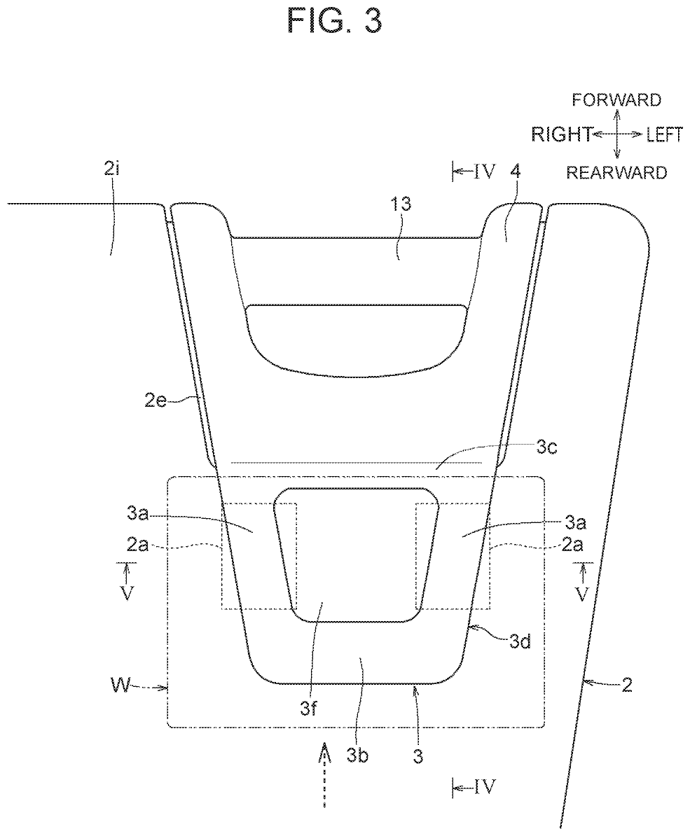

As shown in FIGS. 2 and 3, the fixation mount 4 has a circular arc shape that is curved along the hollowed shape of the holder fixation portion 2e. The fixation mount 4 covers the holder fixation portion 2e from a front side and a rear side. The support rod 13 is provided in the fixation mount 4. Thereby, the support rod 13 is secured to the visor body 2 together with the ticket holder 3. The support rod 13 is positioned on an extended line of the horizontal shaft 11a that is inserted into the visor body 2. As shown in FIG. 4, the fixation mount 4 does not include the ticket holder 3, at a back piece 4a that contacts with the second shell 2c side of the single visor body 2. The visor body 2 includes a back piece engagement portion 2g on the second shell 2c side of the holder fixation portion 2e. The back piece engagement portion 2g is recessed along the shape of the back piece 4a of the fixation mount 4.

As shown in FIGS. 3 and 4, the ticket holder 3 holds a ticket W in cooperation with the visor body 2. Examples of the ticket W include a coupon, an admission ticket, and a thin plate-shaped member. The ticket W may be made of paper or made of resin, and the material does not matter. The ticket holder 3 includes a holder piece 3d that extends rearward from the fixation mount 4. For example, the ticket holder 3 is formed of a resin-made material or the like.

As shown in FIGS. 3 and 4, the holder piece 3d extends from a rearward end of the fixation mount 4 along the visor body 2. The holder piece 3d includes a base portion 3c, right and left pressing portions 3a that extend from the base portion 3c, and a distal end portion 3b. The base portion 3c extends in the right-left direction along the rearward end of the fixation mount 4. The right and left pressing portions 3a extend rearward from right and left ends of the base portion 3c. For the right and left pressing portions 3a, the distance between each other becomes closer toward distal ends. The distal end portion 3b couples the distal ends of the right and left pressing portions 3a. The holder piece 3d includes an opening portion 3f that is surrounded by the pressing portions 3a, the distal end portion 3b and the base portion 3c. The ticket W is inserted into a gap between the ticket holder 3 and the visor body 2 from the distal end portion 3b of the ticket holder 3 toward the base portion 3c.

As shown in FIGS. 3 and 4, the base portion 3c of the ticket holder 3 is curved to the front side while getting away from the fixation mount 4. At a longitudinal center, the pressing portion 3a includes a convex portion 3g that bulges toward the side of the visor body 2. The convex portion 3g includes an inclined surface that gradually advances toward the side of the visor body 2 from the distal end portion 3b toward the base portion 3c. Because of this configuration, when the ticket W is put from the distal end portion 3b into a gap between the holder piece 3d of the ticket holder 3 and the visor body 2, the holder piece 3d is pressed by the ticket W, and is elastically deformed in a direction of getting away from a front surface of the visor body 2. On the other hand, the ticket W is guided by the convex portion 3g, and thereby is smoothly inserted. Furthermore, the ticket W is pressed toward the front surface of the visor body 2 by the convex portion 3g.

As shown in FIG. 4, a securing portion 6 that is secured to the visor body 2 is provided on the fixation mount 4. The securing portion 6 has a plate shape, and extends rearward from a forward edge of the fixation mount 4. The securing portion 6 is positioned on the back side of the holder piece 3d, and extends from the fixation mount 4 roughly parallel to the holder piece 3d. The securing portion 6 includes, at a rearward end portion, a hole 6a having a quadrangular shape that is long in the right-left direction, (see FIG. 2). The hole 6a of the securing portion 6 is positioned at a place facing the opening portion 3f of the holder piece 3d. The securing portion 6 is put in between the first shell 2b and the second shell 2c, from the holder fixation portion 2e of the visor body 2. The hole 6a of the securing portion 6 is latched by a claw 2f that is provided on the second shell 2c. The fixation mount 4 includes retaining portions 4b at right and left edges that contact with both right and left ends of the support rod 13 (see FIG. 2). When the fixation mount 4 is secured to the visor body 2, the retaining portions 4b are fit with the holder fixation portion 2e. Thereby, the fixation mount 4 and the holder fixation portion 2e can restrain the wobble of the ticket holder 3 in the front-back direction, in cooperation.

As shown in FIGS. 3 and 4, at least one, for example, right and left escape portions 2a are formed on the front surface of the visor body 2. The right and left escape portions 2a are respectively positioned at places where the front surface of the first shell 2b faces the right and left convex portions 3g of the ticket holder 3. The right and left escape portions 2a have a quadrangular shape, for example, and are long in the forward-rearward direction. The escape portion 2a passes from the front surface of the visor body 2 to a hollow portion. The width of the escape portion 2a is wider than the width of the convex portion 3g, and the convex portion 3g is positioned within the width of the escape portion 2a. Therefore, the escape portion 2a avoids the convex portion 3g from receiving force directly from the visor body 2. Thereby, the load that is given from the visor body 2 to the ticket holder 3, for example, the load that is applied to the base portion 3c is reduced.

As shown in FIGS. 4 and 5, the visor body 2 and the escape portion 2a are covered by a coat 2d. The coat 2d is formed of a material made of a soft resin such as a vinyl chloride resin, for example.

As described above, the vehicle sun visor 1 includes the plate-shaped visor body 2 as shown in FIG. 2. The ticket holder 3 that holds the ticket W in cooperation with the visor body 2 is secured to the visor body 2. The visor body 2 includes the escape portions 2a that pass through the front surface of the visor body 2, at the positions facing the ticket holder 3.

As shown in FIG. 4, when the ticket W is inserted between the ticket holder 3 and the visor body 2, the ticket holder 3 is elastically deformed. The ticket W is pressed by the ticket holder 3, and is elastically deformed toward the escape portions 2a. Therefore, the ticket W is held between the ticket holder 3 and the visor body 2, using both of the elastic deformation of the ticket holder 3 and the elastic deformation of the ticket W itself. The ticket W is elastically deformed toward the escape portion 2a, and therefore, even when the thickness of the ticket W is large, the ticket W is held between the ticket holder 3 and the visor body 2, using the escape portions 2a. In the other words, the ticket W having a large thickness can be held between the ticket holder 3 and the visor body 2, while the escape portions 2a avoid the ticket holder 3 from being elastically deformed highly.

As shown in FIG. 4, the ticket holder 3 includes the convex portions 3g that bulge toward the side of the visor body 2. The escape portions 2a are positioned so as to face the convex portions 3g. Accordingly, the ticket W is elastically deformed surely toward the escape portions 2a of the visor body 2, using the convex portions 3g of the ticket holder 3. Thus, the ticket W can be elastically deformed surely. Moreover, by being pressed by the convex portions 3g, the ticket W is restrained from falling out of between the ticket holder 3 and the visor body 2.

As shown in FIG. 5, the escape portion 2a of the visor body 2 has such a width length that the escape portion 2a expands beyond both mutually facing edges of the convex portion 3g of the ticket holder 3. Accordingly, the convex portion 3g is positioned within the width of the escape portion 2a. Therefore, a first portion of the ticket W that faces the convex portion 3g is easily pressed by the convex portion 3g, into the escape portion 2a or toward the escape portion 2a. On the other hand, second portions of the ticket W on both side of the first portion are easily returned to both sides of the convex portion 3g through the escape portion 2a. Therefore, the ticket W can be elastically deformed surely.

As shown in FIG. 4, the convex portion 3g of the ticket holder 3 includes the inclined surface that gradually advances toward the visor body 2, from the distal end into which the ticket W is inserted, toward the base portion 3c of the ticket holder 3. Accordingly, by inserting the ticket W into the ticket holder 3, the ticket W is elastically deformed smoothly to the side of the visor body 2 along the convex portion 3g of the ticket holder 3.

By providing the escape portions 2a on the visor body 2 as shown in FIG. 4, it is possible to avoid the ticket holder 3 from being elastically deformed highly. Thereby, the load that is applied to the base portion 3C is reduced. Accordingly, it is possible to restrain deformation, breakage and the like due to temperature change, time lapse or the like, and to maintain the holding performance of the ticket holder 3 for a long term.

As shown in FIGS. 4 and 5, the vehicle sun visor 1 includes the coat 2d that covers the visor body 2 and the escape portions 2a. Accordingly, the ticket holder 3 presses the coat 2d toward the escape portions 2a of the visor body 2. The coat 2d is elastically deformed so as to be recessed at the escape portions 2a. When the ticket W is put in between the coat 2d and the ticket holder 3, the coat 2d prevents the ticket W from being caught by the escape portions 2a. Thereby, the ticket W is smoothly put in a gap between the ticket holder 3 and the visor body 2. Moreover, since the escape portions 2a of the visor body 2 is covered by the coat 2d, the vehicle sun visor 1 having a good appearance is obtained.

As shown in FIG. 2, the vehicle sun visor 1 includes the support rod 13 (support shaft) that is attached to and detached from a vehicle body, and the fixation mount 4 that secures the support rod 13 to the visor body 2. The ticket holder 3 is provided on the fixation mount 4. Accordingly, the ticket holder 3 is secured to the visor body 2, using the fixation mount 4 that secures the support rod 13 to the visor body 2. Thereby, it is possible to reduce the number of components of the vehicle sun visor 1, or it is possible to simplify the production process for the vehicle sun visor 1.

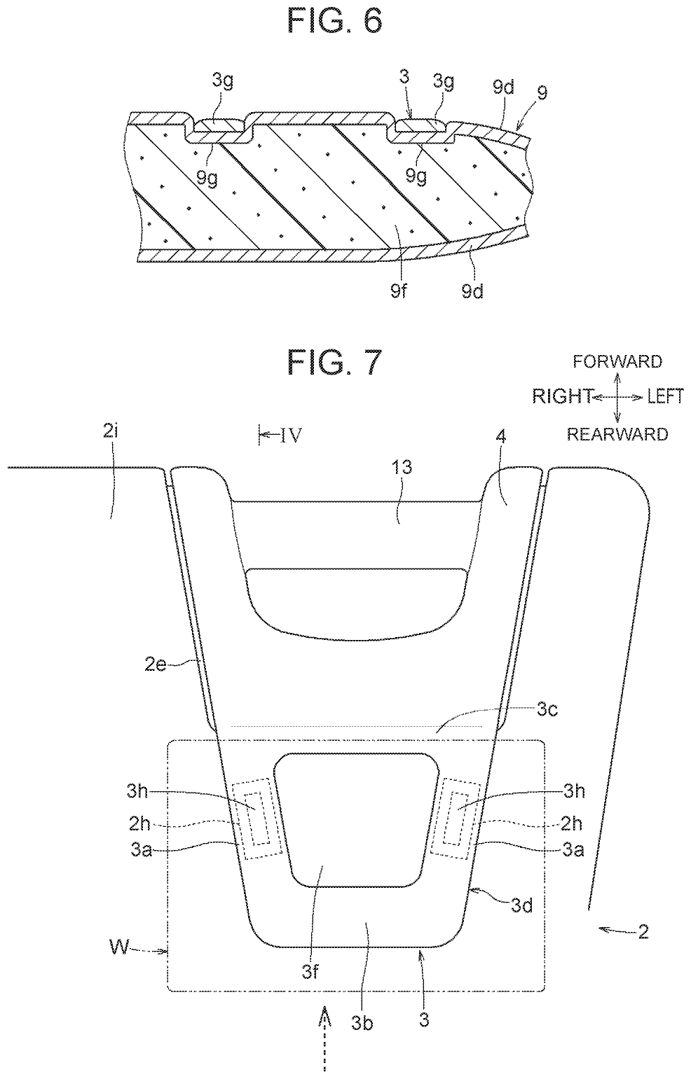

The present disclosure is not limited to the external appearance and configuration of the embodiment disclosed in FIGS. 1 to 5, and various alterations, additions and deletions can be made within a range in which the gist is not changed. For example, the visor body 2 shown in FIGS. 2 and 5 includes the escape portions 2a that are through-holes. Instead of this visor body 2, the vehicle sun visor 1 may include a visor body 9 shown in FIG. 6. The visor body 9 shown in FIG. 6 has a solid plate shape in which a foam material 9f (for example, PP foam beads, urethane foam or the like) is used.

As shown in FIG. 6, the visor body 9 includes escape portions 9g having a concave shape, instead of the escape portions 2a shown in FIG. 5. At least one escape portion 9g, for example, two right and left escape portions 9g are formed on the front surface of the visor body 9. The escape portions 9g are recessed to the inside in the thickness direction from the front surface of the visor body 9. The right and left escape portions 9g are respectively positioned at places where the front surface of the visor body 9 faces the right and left convex portions 3g of the ticket holder 3. The right and left escape portions 9g have a quadrangular shape in planar view, for example, and are long in the forward-rearward direction. The visor body 9 and the escape portions 9g are covered by a coat 9d. The coat 9d is along the escape portions 9g by being pressed by the convex portions 3g of the ticket holder 3.

The visor body 2 may include escape portions 2h shown in FIG. 7, instead of the escape portions 2a shown in FIG. 2. The escape portions 2h have a narrower width than the width of the right and left pressing portions 3a of the ticket holder 3. The pressing portion 3a of the ticket holder 3 may include a convex portion 3h shown in FIG. 7, instead of the convex portion 3g shown in FIG. 2. The convex portion 3h projects from the pressing portion 3a toward the escape portion 2h. The convex portion 3h has a quadrangular shape in planar view, for example. The convex portion 3h is positioned within a region of the escape portion 2h in planar view, and is shorter in the forward-rearward direction and shorter in the right-left direction than the escape portion 2h. In other words, the escape portion 2h has such a width length that the escape portion 2h expands beyond the left edge and right edge of the convex portion 3h of the ticket holder 3.

As shown in FIG. 7, the escape portion 2h has such a length that the escape portion 2h expands beyond the forward edge and rearward edge of the convex portion 3h. Accordingly, the first portion of the ticket W that faces the convex portion 3h is easily pressed by the convex portion 3h, into the escape portion 2h or toward the escape portion 2h, not only in the right-left direction but also in the forward-rearward direction. On the other hand, the second portions of the ticket W on both sides of the first portion are easily returned to both sides of the convex portion 3h through the escape portion 2h. Therefore, it is easy to elastically deform the ticket W also in the forward-rearward direction.

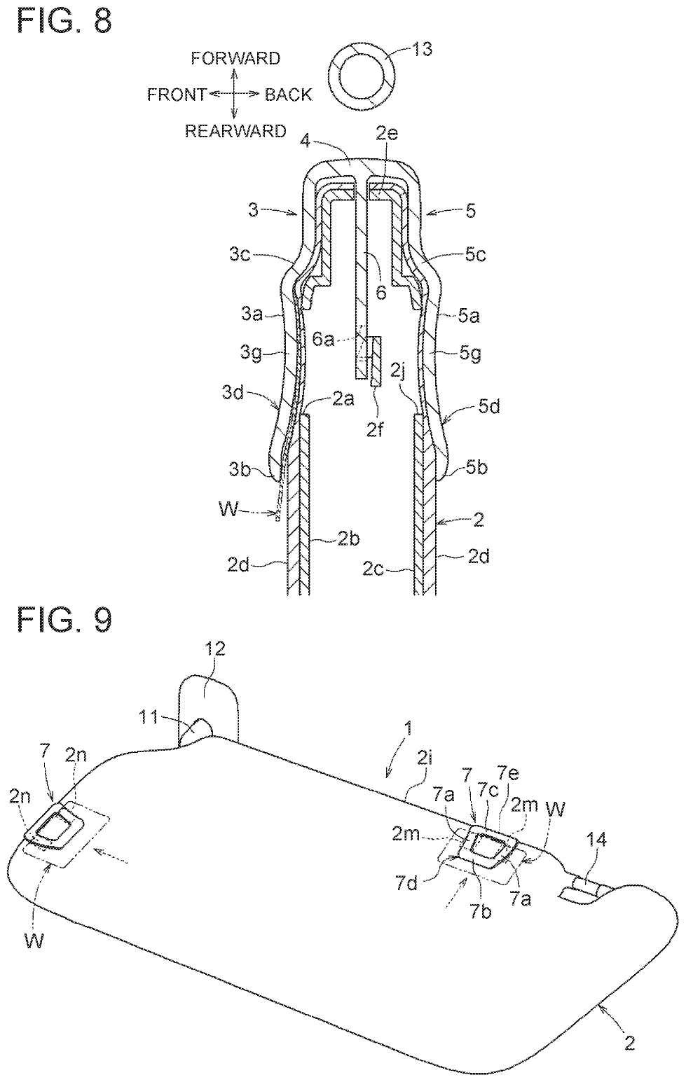

As shown in FIG. 4, the ticket holder 3 is provided only on one side surface of the visor body 2. Instead of this, as shown in FIG. 8, ticket holders 3, 5 may be provided on both surfaces of the visor body 2. The second ticket holder 5 is provided at a back side edge of the fixation mount 4, instead of the back piece 4a of the fixation mount 4 shown in FIG. 4. The second ticket holder 5 is disposed on the back surface of the front surface of the visor body 2 on which the ticket holder 3 is provided. The ticket holder 3 and the second ticket holder 5 are integrally secured to the visor body 2. The second ticket holder 5 includes a holder piece 5d that includes pressing portions 5a, a distal end portion 5b, a base portion 5c and convex portions 5g, similarly to the holder piece 3d that includes the pressing portion 3a, distal end portion 3b, base portion 3c and convex portion 3g of the ticket holder 3.

Thereby, the ticket W can be held on both surfaces of the visor body 2, and therefore, the ticket holders 3, 5 can be used in the case of both the use position P where the visor body 2 is along the windshield 20 and the stowed position K where the visor body 2 is along the ceiling surface 21. Moreover, the two ticket holders 3, 5 are integrated, and therefore are held by the visor body 2 in cooperation.

As shown in FIG. 8, on the visor body 2, an escape portion 2j is formed at a position facing the pressing portion 5a of the second ticket holder 5. The escape portion 2j is formed similarly to the escape portion 2a shown in FIG. 5.

The vehicle sun visor 1 may include a support rod 14 and ticket holder 7 shown in FIG. 9, instead of the support rod 13 and ticket holder 3 shown in FIG. 2. The support rod 14 is attached to a portion that is hollowed rearward, at the forward edge 2i of the visor body 2. The support rod 14 is positioned coaxially with the horizontal shaft 11a of the supporting shaft 11.

As shown in FIG. 9, the ticket holder 7 is secured to an arbitrary position of one or both of a long edge and short edge of the visor body 2. The ticket holder 7 includes a holder piece 7d that holds the ticket W. For example, holder pieces 7d are disposed on both surfaces of the visor body 2. Each of the holder pieces 7d extends along the front surface or back surface of the visor body 2. Each of the front and back holder pieces 7d includes a base portion 7c, pressing portions 7a that extend from the base portion 7c, and a distal end portion 7b. The ticket holder 7 includes a coupling portion 7e that couples the front and back holder pieces 7d. The coupling portion 7e extends in the right-left direction along the front and back base portions 7c that are coupled. The ticket holder 7 is elastically deformed, and is secured to the visor body 2. The coupling portion 7e contacts with the long edge or short edge of the visor body 2.

The ticket holder 7 shown in FIG. 9 can be secured to an end edge of the visor body 2 from any side of the forward, rearward, right and left sides, without the fixation mount. Accordingly, the secured position of the ticket holder 7 can be selected depending on the specification of the visor body 2, and the like. The visor body 2 includes, on the front surface and the back surface, escape portions 2n, 2m at positions facing the pressing portion 7a of the ticket holder 7. For example, the escape portions 2n, 2m are formed similarly to the escape portion 2a shown in FIG. 5, the escape portion 9g shown in FIG. 6 or the escape portion 2h shown in FIG. 7. Convex portions that project toward the escape portions 2n, 2m may be provided on the pressing portions 7a of the ticket holder 7. A plurality of ticket holders 7 may be secured for one vehicle sun visor 1.

The vehicle sun visor 1 may include a ticket holder 8 shown in FIG. 10, instead of the ticket holder 3 shown in FIG. 2. The vehicle sun visor 1 shown in FIG. 10 includes a trim 16a for a vanity mirror 16 that is secured to the visor body 2. The ticket holder 8 extends from an end edge of the trim 16a. The vanity mirror 16 has a rectangular shape, and is secured to the surface of one side of the visor body 2. The trim 16a having a frame shape is provided at a circumferential edge of the vanity mirror 16.

As shown in FIG. 10, the ticket holder 8 includes a holder piece 8d that extends from the end edge of the trim 16a along the visor body 2. The holder piece 8d includes a base portion 8c, forward and rearward pressing portions 8a that extend from the base portion 8c, and a distal end portion 8b. The base portion 8c extends from one short edge of the trim 16a in a direction of getting away from the mirror 16. The forward and rearward pressing portions 8a extend from forward and rearward ends of the base portion 8c in the direction of getting away from the mirror 16. For the forward and rearward pressing portions 8a, the distance between each other becomes closer toward distal ends. The distal end portion 8b couples the distal ends of the forward and rearward pressing portions 8a. The holder pieces 8d includes an opening portion 8f that is surrounded by the pressing portions 8a, the distal end portion 8b and the base portion 8c.

As shown in FIG. 10, the visor body 2 includes, on the front surface, escape portions 2p at positions facing the pressing portions 8a of the ticket holder 8. For example, the escape portion 2p is formed similarly to the escape portion 2a shown in FIG. 5, the escape portion 9g shown in FIG. 6 or the escape portion 2h shown in FIG. 7. Convex portions that project toward the escape portions 2p may be provided on the pressing portions 8a of the ticket holder 8. The ticket holder 8 is secured to the visor body 2 by securing the trim 16a of the mirror 16 to the visor body 2. Thereby, it is possible to reduce the number of components of the vehicle sun visor 1, or it is possible to simplify the production process for the vehicle sun visor 1.

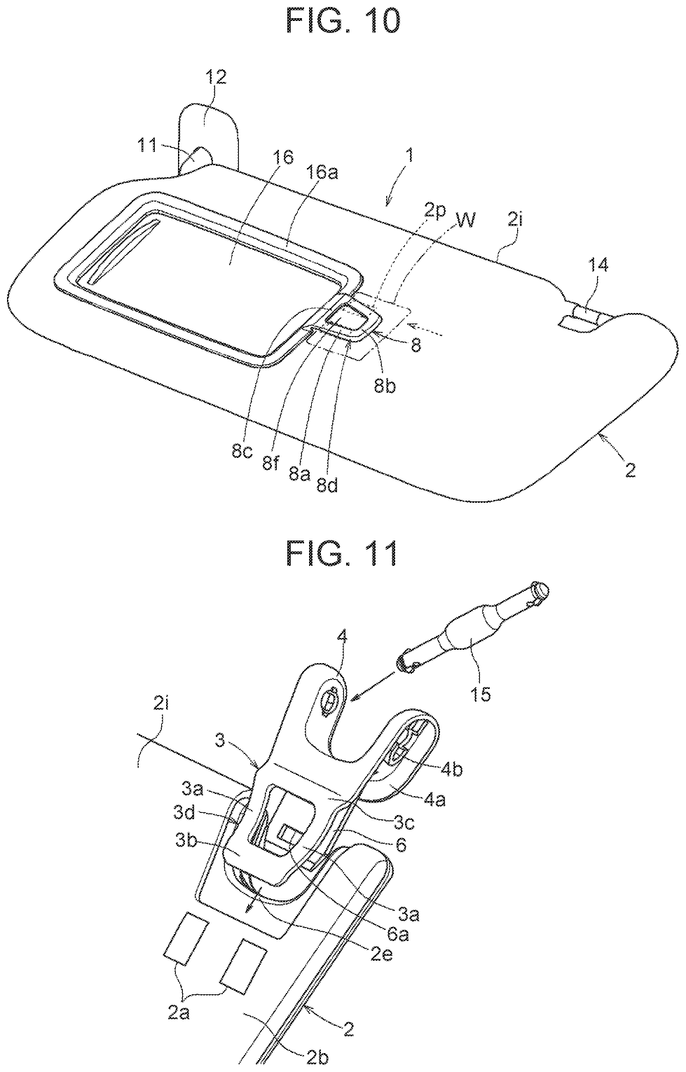

The ticket holder 3 shown in FIG. 2 is integrated with the support rod 13 and the fixation mount 4, as one component. Instead of this support rod 13, as shown in FIG. 11, the support rod 15 may be isolated from the ticket holder 3 and the fixation mount 4, as a separate component. The support rod 15 may have a solid shape, instead of a roughly columnar hollow shape, and may have a shape in which the diameter around the axis partially differs. After the ticket holder 3 and the fixation mount 4 are secured to the visor body 2, the support rod 15 is secured at a coaxial position with the horizontal shaft 11a of the visor body 2. In addition, the ticket holder 3 and the fixation mount 4 may be isolated as separate components.

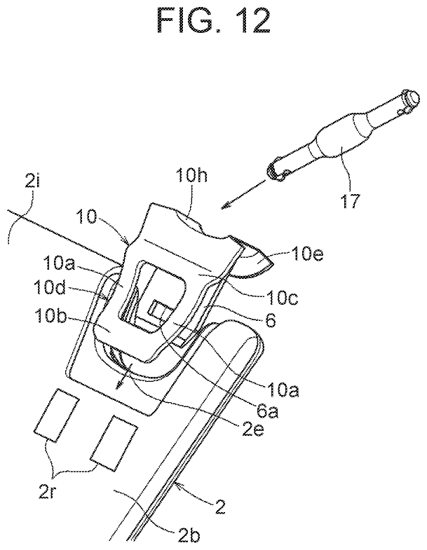

The vehicle sun visor 1 may include a ticket holder 10 and support rod 17 shown in FIG. 12, instead of the ticket holder 3 shown in FIG. 2. The support rod 17 has a solid bar shape, and the diameter of an axially central portion is larger than both ends. The ticket holder 10 shown in FIG. 12 includes a holder piece 10d that holds the ticket W. For example, the holder piece 10d is disposed on the front surface of the visor body 2. The holder piece 10d extends along the front surface of the visor body 2. The holder piece 10d includes a base portion 10c, pressing portions 10a and a distal end portion 10b. The holder piece 10d is formed similarly to the holder piece 3d of the ticket holder 3 shown in FIG. 2. The ticket holder 10 includes a back piece 10e that is disposed on the back surface of the visor body 2 and a coupling portion 10h that couples the holder piece 10d and the back pieces 10e. The coupling portion 10h extends in the right-left direction along the base portion 10c.

As shown in FIG. 12, the coupling portion 10h of the ticket holder 10 includes a securing portion 6 that is secured to the visor body 2. The securing portion 6 has a plate shape, and extends rearward from the coupling portion 10h. The securing portion 6 is formed similarly to the securing portion 6 of the ticket holder 3 shown in FIG. 4. The ticket holder 10 is secured to the holder fixation portion 2e on the rearward side of the support rod 17. After the ticket holder 10 is secured to the visor body 2, the support rod 17 is secured coaxially with the horizontal shaft 11a of the visor body 2. The visor body 2 includes, on the front surface, escape portions 2r at positions facing the pressing portions 10a of the ticket holder 10. For example, the escape portion 2r is formed similarly to the escape portion 2a shown in FIG. 5, the escape portion 9g shown in FIG. 6 or the escape portion 2h shown in FIG. 7. Convex portions that project toward the escape portions 2r may be provided on the pressing portions 10a of the ticket holder 10.

The position and orientation of the ticket holder 3 that is secured to the visor body 2 are arbitrarily set depending on the specification of the vehicle, and the like. For example, in a state where the vehicle sun visor 1 shown in FIG. 1 is positioned at the stowed position K where the visor body 2 is along the ceiling surface 21, the ticket W is inserted into the ticket holder 3. Instead of this, the ticket holder 3 may be secured such that the ticket W is inserted in a state where the vehicle sun visor 1 is positioned at the use position P where the visor body 2 is along the windshield 20.

To the visor body 2 shown in FIGS. 2 and 11, the ticket holder 3 provided on the fixation mount 4 is secured together with the fixation mount 4. Instead of this, only the ticket holder 3 may be mounted to the visor body 2, without the fixation mount 4.

The visor body 2 and escape portions 2a shown in FIG. 3 are covered by the coat 2d. As the coat 2d, various kinds and thicknesses can be arbitrarily selected. Furthermore, the size and others of the escape portion 2a can be appropriately set depending on the kind and thickness of the coat 2d. Thereby, even the ticket W having a large thickness is elastically deformed toward the escape portions 2a by the convex portions 3g, and is stably held. Instead of covering the whole of the visor body 2 with the coat, surface treatment may be performed with a plate-shaped member made of resin or the like. Furthermore, the coat 2d may cover only the escape portions 2a.

The convex portion 3g of the ticket holder 3 shown in FIG. 4 has the inclined surface that gradually advances toward the side of the visor body 2 from the distal end portion 3b toward the base portion 3c. Instead of this, the escape portion of the visor body 2 and the convex portion 3g of the ticket holder 3 are set to various shapes and sizes, depending on the specification of the visor body 2, and the like. For example, a quadrangular convex portion having a smaller length and width than those of the pressing portion 3a may project from the holder piece toward the escape portion. Furthermore, the shape of the convex portion that projects may be another shape such as a circular arc shape.

The holder piece 3d of the ticket holder 3 shown in FIG. 3 includes the opening portion 3f. Instead of this, the ticket holder 3 may include a holder piece having no opening portion. For example, right and left convex portions may project from pressing portions having the same width as the holder piece.

For the ticket holder 3 shown in FIGS. 2 and 4, the hole 6a of the securing portion 6 is latched by the claw 2f that is provided on the second shell 2c. Instead of this securing portion 6, the ticket holder 3 may include a securing portion that is provided with a claw. For example, when the securing portion including the claw is put in the visor body 2, the claw of the securing portion is latched by a latch member in the visor body 2.

The visor body 2 shown in FIG. 5 has a hollow plate shape in which the first shell 2b and the second shell 2c overlap. Instead of this, the visor body 2 may have a hollow plate shape that is made by blow molding. Further, a solid plate shape may be formed of PP foam beads, urethane foam or the like.

### REFERENCE SIGNS LIST

1 vehicle sun visor
2 visor body
2a escape portion
2b first shell
2c second shell
2d coat
2e holder fixation portion
3 ticket holder
3a pressing portion
3b distal end portion
3c base portion
3d holder piece
3f opening portion
3g convex portion
4 fixation mount
5 second ticket holder
6 securing portion
11 supporting shaft
12 bracket
13 support rod (support shaft)
W ticket

1. A vehicle sun visor with a ticket holder, comprising:
a visor body having a plate shape; and
the ticket holder secured to the visor body and configured to hold a ticket in cooperation with the visor body, wherein
the visor body includes an escape portion that passes through a front surface of the visor body or is provided so as to be recessed into the front surface of the visor body, at a position facing the ticket holder.

2. The vehicle sun visor with the ticket holder according to claim 1, wherein:
the ticket holder includes a convex portion that bulges toward a side of the visor body; and
the escape portion faces the convex portion.

3. The vehicle sun visor with the ticket holder according to claim 2, wherein the escape portion has such a width length that the escape portion expands beyond both mutually facing edges of the convex portion.

4. The vehicle sun visor with the ticket holder according to claim 2, wherein the convex portion of the ticket holder includes an inclined surface that gradually advances toward the side of the visor body from a distal end into which a ticket is inserted toward a base portion of the ticket holder.

5. The vehicle sun visor with the ticket holder according to claim 1, further comprising a coat covering the visor body and the escape portion.

6. The vehicle sun visor with the ticket holder according to claim 1, further comprising:
a support shaft configured to be attached to and detached from a vehicle body; and
a fixation mount configured to secure the support shaft to the visor body, wherein
the ticket holder is provided on the fixation mount.

7. The vehicle sun visor with the ticket holder according to claim 1, further comprising a second ticket holder disposed on a back surface of the front surface of the visor body, the ticket holder being provided on the front surface of the visor body, wherein
the ticket holder and the second ticket holder are configured to be integrally secured to the visor body.

8. The vehicle sun visor with the ticket holder according to claim 1, further comprising a trim for a vanity mirror that is secured to the visor body, wherein
the ticket holder extends from an end edge of the trim.
